(19) United States
(12) Patent Application Publication
(10) Pub. No.: US 2009/0108498 A1
(43) Pub. Date: Apr. 30, 2009

(54) Drive for an Injection Unit and Method of Operating the Drive Unit

(75) Inventor: Andreas UJMA, Merzig (DE)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/923,679

(22) Filed: Oct. 25, 2007

(51) Int. Cl. B29C 45/82

(52) U.S. Cl. 264/310; 425/161; 425/163

(57) ABSTRACT

An injection molding machine conventionally includes a hydraulic circuit that communicates energy from a first motor. The hydraulic circuit typically includes pumps that regulate, in a conventional fashion, the flow of hydraulic fluid to control molding sub-assembles and functions, such as clamp up, stroke and injection. Additionally and conventionally, a dedicated electric drive is coupled to an extruder to effect rotation and operation thereof. According to the invention, the hydraulic circuit is extended to include a hydraulic motor drive whose operation is to rotate the extruder, thereby permitting the dedicated electric drive and its associated frequency and power control circuitry to be eliminated. By making use of previous idle periods when conventionally-driven hydraulic molding functions are effectively inoperative but when energy is nevertheless supplied to pumps by the first motor, the hydraulic drive is able to receive “free” energy from the first motor and to convert this into rotational energy to drive the extruder. In this way, the timing of operations in the molding machine is orchestrated such that the first motor can effectively provide contiguous or sequential support of multiple system functions, including extruder rotation, through a common but system-extensive hydraulic circuit.

### FIELD OF THE INVENTION

This invention relates, in general, to drive units and is particularly, but not exclusively, applicable to hydraulic pumps and their use in injection molding machines (or the like). More specifically, the present invention relates to drives associated with twin screw extruders.

### SUMMARY OF THE PRIOR ART

In today's world, energy efficiency is of considerable concern from the perspectives of both financial cost and environmental impact. With energy inefficient systems, a manufacturer's overhead costs are increased and their profit margins accordingly reduced. Injection molding system suppliers and their customers are therefore keen to see energy savings in new system design, especially in application involving large clamp tonnage machines (typically above 10000 kN) where component scaling means that component/sub-assembly masses and energy consumption are both significant.

Injection molding machines make use of hydraulic circuits and particularly hydraulic pumps to control machine functions, including clamp unit functions and melt injection functions. In this general regard, oil from a central oil reservoir is pumped around the injection molding machine by an electric motor, with this motor providing energy to multiple hydraulic pumps used in particular circuits for particular functions. One such system was supported in the Moduline G-Series of injection molding machines manufactured and supplied by Husky Injection Molding Systems Limited.

In European patent EP-B-1343622, an electric motor is connected to a hydraulic motor via a transmission device, such as a belt. As the electric motor turns a feed screw (to effect plasticizing in the injection barrel of an extruder), the electric motor is also used to power a hydraulic motor that is tasked to charge one or more accumulators. The stored hydraulic energy in the accumulator may then used: i) to stroke pistons to open and close clamp unit; ii) to generate clamp tonnage by controlling pressure in clamp pistons; and/or iii) to cause the injection of melt into the mold. Furthermore, a clutch mechanism may be provided between the electric motor and the feed screw such that the electric motor may be disengaged from the feed screw. During times of disengagement, the electric motor is permitted to drive continuously the hydraulic motor and therefore to charge the hydraulic accumulator. More specifically, the clutch mechanism allows the electric motor to remain “on” to charge the accumulator during the injection cycle.

In terms of screw/extruder operation and particularly screw rotation, current injection molding systems can use both hydraulic and electric motors that are dedicated to this sole function. Such screws may furthermore be subject to either continuous or discontinuous operation, and such screws may furthermore operate on a reciprocating or fixed axial basis. The extruder may, furthermore, support single or multiple screws. For example, in a compounding environment, it is usual to make use of an intermeshed, co-rotating twin screw extruder (TSE) to reduce internal melt stresses while producing homogeneity in the melt.

Furthermore, existing injection molding systems, such as in-line compounding systems, have complex control circuits associated with the electric or hydraulic screw drives. Such controls are generally housed in dedicated cabinets that are located proximate to a distal end of the injection unit (i.e. at the end of the feed screw remote from the nozzle). These cabinets hold dedicated power supplies and expensive frequency control equipment that cooperate to control operation and torque in the electric motor that causes rotation of the screw through (typically) a gear box and associated clutch arrangement. As will be appreciated, the clutch and gear box combination therefore provide a mechanism for regulating potentially damaging levels of torque generated in the motor. Additionally, these control cabinets are not insignificant in size and may typically have a footprint and volume of ˜1 m² and ˜2 m³, respectively.

### SUMMARY OF THE INVENTION

According to a first aspect of the present invention there is provided an injection molding machine comprising: a twin screw extruder including at least one rotating screw; a power pack including: a motor; a plurality of pumps each for effecting an injection molding function; and a hydraulic circuit coupling the motor to the plurality of pumps such that the motor can selectively provide energy to each pump to manage its respective molding machine function; a hydraulic motor drive coupled to the twin screw extruder to effect and control rotation of the twin screw extruder, the hydraulic motor drive connected into the hydraulic circuit such that the hydraulic motor drive selectively receives energy from the motor to cause controlled rotation of the twin screw extruder.

In a preferred embodiment, a variable displacement pump is coupled between the motor and the hydraulic motor drive, wherein the variable displacement pump is arranged, in use, to provide hydraulic energy to the motor at least during one period when one of the plurality of pumps is idle and thus not operational to support its respective injection molding function.

In a second aspect of the present invention there is provided a method of operating an injection molding machine comprising: a twin screw extruder; a power pack having a hydraulic circuit, a plurality of pumps each controlling an active injection molding function and a motor coupled to the plurality of pumps through the hydraulic circuit selectively to actuate each injection molding function; and a hydraulic motor drive connected to the hydraulic circuit and the twin screw extruder, the method comprising: drawing energy from the motor in the power pack to operate the hydraulic motor drive to cause rotation of the twin extruder, the energy provided during at least a period of time when at least one of the plurality of pumps is idle and thus not actively supporting its assigned injection molding function.

In a further aspect of the present invention there is provided a method of operating a twin screw extruder in a molding machine having a plurality of pump-controlled machine functions, the method comprising: in periods where the pump-controlled machine functions are inoperative, using available energy from a motor dedicated to the pump-controlled machine functions to energize a hydraulic motor drive to cause controlled rotation of the twin screw extruder.

Advantageously, the present invention provides increased energy efficiency achieved from costs savings arising from the elimination of idle losses in the pump power pack. Furthermore, the present invention reduces investment costs, since no dedicated electric (rotational drive) motor for the plasticizing unit needs to be supplied in the injection molding system. Moreover, with the elimination of a dedicated motor for the screw/extruder, its associated power supply and frequency controller (used to control the speed and torque of the electric motor) can also be eliminated, thereby saving additional costs and space (in terms of elimination of the dedicated control cabinet and a corresponding reduction in overall machine length/height).

The timing of operations in the molding machine is therefore orchestrated such that a common motor within a power pack can effectively and advantageously provide contiguous or sequential support of multiple system functions, including extruder rotation, through a common but system-extensive hydraulic circuit.

### BRIEF DESCRIPTION OF THE DRAWINGS

Exemplary embodiments of the present invention will now be described with reference to the accompanying drawings, in which:

FIG. 1 is a schematic representation of a conventional (prior art) machine platform, including an extruder drive;

FIG. 2 is a schematic representation of a hydraulic-extruder drive according to the present invention;

FIG. 3 is a hydraulic circuit diagram of the hydraulic-extruder drive according to FIG. 2;

FIG. 4a is timing diagram that shows relative timing of hydraulically controlled machine functions in a prior art system having a reciprocating screw (RS) operating a sequential plasticizing process;

FIG. 4b is timing diagram that shows relative timing of hydraulically controlled machine functions in a prior art system having a reciprocating screw (RS) operating a simultaneous plasticizing process;

FIG. 4c is timing diagram that shows relative timing of hydraulically controlled machine functions in a prior art system having a shooting pot machine configuration operating a discontinuous plasticizing process;

FIG. 4d is timing diagram that shows relative timing of hydraulically controlled machine functions in a prior art system having a melt-buffered compounding machine configuration operating a continuous plasticizing process; and

FIG. 5 is timing diagram that shows relative timing of hydraulically controlled machine functions for the system of FIG. 3.

### DETAILED DESCRIPTION OF A PREFERRED EMBODIMENT

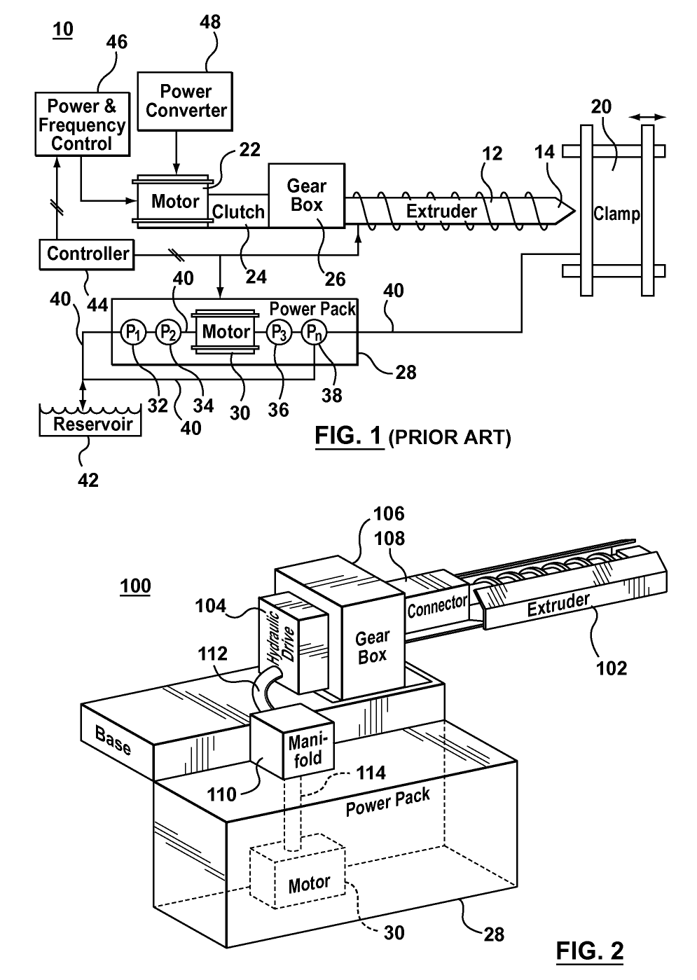

Referring to FIG. 1, a schematic representation of a conventional (prior art) machine platform 10, including an extruder-drive, is shown. Particularly, an extruder 12 includes a nozzle 14 that interfaces into a mold (not shown) positioned between a moving platen 16 and a stationary platen 18 of a clamp unit 20. An electric motor 22 effects rotation of the screw or screws (not shown) in the extruder 12, with the electric motor coupled to the extruder through an series arrangement of a clutch 24 and gearbox 26.

A hydraulic power pack 28 includes an electric motor 30 that provides energy to a multiplicity of hydraulic pumps 32-38 that are located within a hydraulic circuit 40, including a reservoir 42 from which (and to which) hydraulic fluid, e.g. oil, is drawn and delivered. Specific ones of these hydraulic pumps 33-38, each responsive to the control of a machine controller 44, operate to support a variety of conventional molding machine functions, including: i) stroking of the moving platen; ii) injection; iii) clamp and lock functions within the clamp unit 20; and iv) integrated in-mold functions, e.g. the operative control of core ejectors.

The machine controller 44 also orchestrates operational control of additional machine functions, e.g. continuous or discontinuous operation of the extruder and also power supply and general operation of the electric motor 22 associated with the extruder 12. In the latter respect, the machine platform 10 further includes dedicated power and frequency control circuitry 46 that operates to control accurately the rotation and translation of the screws in the extruder 12. Additionally, a power converter 48 is associated with the electric motor 22.

On occasion, the electric motor 22 has (in the prior art) been substituted by a dedicated hydraulic motor that is and remains additional/auxiliary to the motors in the power pack 29.

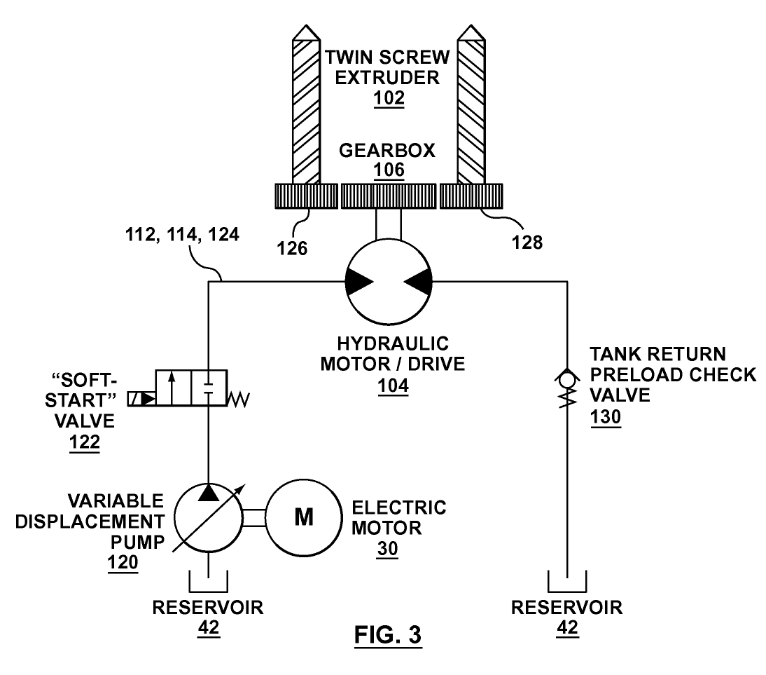

A schematic representation of a hydraulic-extruder drive 100 according to the present invention is shown in FIG. 2. According to the principals of the present invention, the existing electric screw drive of, for example, a twin screw extruder (TSE) 102 in an in-line compounding machine (or the like) is rendered redundant and replaced by a hydraulic drive unit 104 powered by the existing motor 30 in the existing power pack 28. The hydraulic drive unit 104 converts laminar/tubular fluid flow in a hydraulic circuit into rotational energy, thereby effecting the rotation of a gear (or gears) in a gear box 106. With a TSE 102, it would be usual for both screws to be driven by separate gears in the gear box 106. The gear box 106 is typically coupled to the extruder 104 through a connector 108 that effects coupling of the screws to splines in the gearbox 106. Hydraulic fluid in the hydraulic circuit of the power pack is provided to the hydraulic drive unit 104 through a distribution manifold 110 responsive to the machine's controller. Piping 112-114 connects the manifold 110 to both the hydraulic drive unit 104 and the motor 30 in the power pack 28. In this way, compared with the prior art, a dedicated motor, its associated power converter and its power and frequency control circuitry are eliminated. More specifically, as a consequence of making use of the erstwhile “idle” periods in the motor 30 of the power pack to power the hydraulic motor drive 104, the physical size (and particularly an overall length) of the molding system can be reduced, i.e. the dedicated cabinet for the power and frequency control circuitry is eliminated.

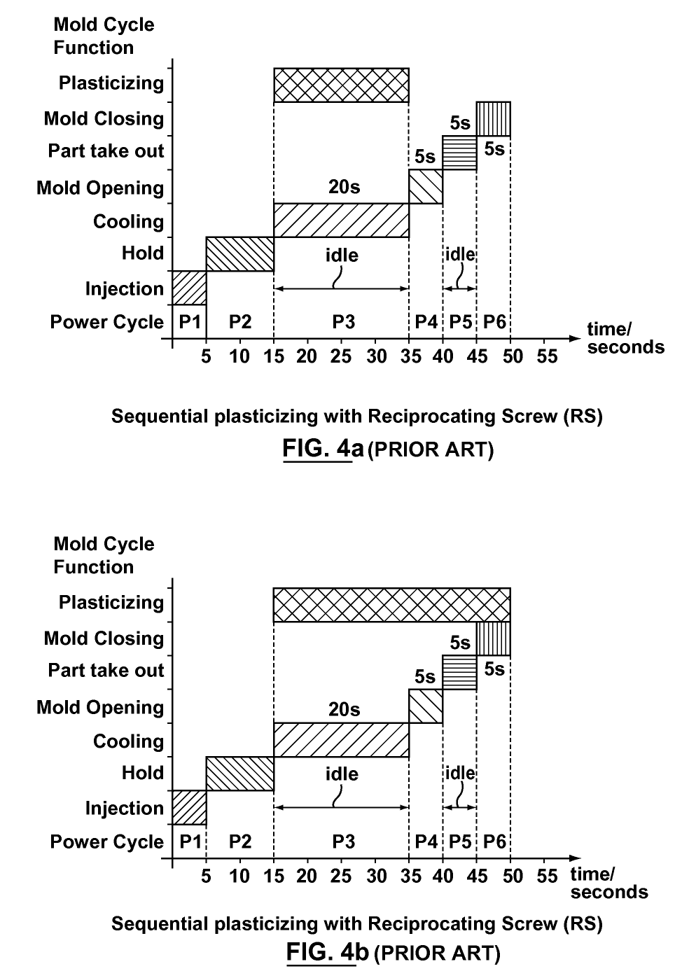

Referring briefly to FIG. 3, there is shown a hydraulic circuit diagram of the hydraulic-extruder drive 100 according to FIG. 2. The electric motor 30 (of the power pack 28) provides energy to a variable displacement pump 120 that draws hydraulic fluid (such as oil) from a connected reservoir 42. The variable displacement pump 120 is coupled to the hydraulic (motor) drive unit 104 through a valve 122. Preferably, the valve 122 is a “soft-start” valve since operation (i.e. start and stop) of the hydraulic drive unit is subject to a ramping effect. More particularly, a dampening cone in the soft-start valve 122 prevents shock in the hydraulic (motor) drive unit 104 and thus avoids hammering of shifting pistons on the motor's cam ring. Without this “soft-start” function, the lifetime of the motor is generally reduced. As previously explained, the hydraulic motor drive 104 converts pressured fluid flow in hydraulic circuit 124 into rotational energy that drives (preferably) two independent gears 126-128 in the gearbox 106 to drive separately each screw.

From a fluid return perspective, hydraulic fluid is returned from the hydraulic motor drive 104 to the reservoir 42 via a tank return valve 130. Preferably, the tank return valve 130 is a preloaded check valve because the supply and return lines (in the hydraulic circuit 40) need to be pressurized (when the hydraulic motor 104 stops) to eliminate short-term shifting of the hydraulic motor's pistons due to gravity. In addition, inclusion of the preloaded circuit will smoothly bring the pistons into position during start up of the TSE 102. The variable pump 120 therefore controls oil volume flow to the hydraulic motor drive 104.

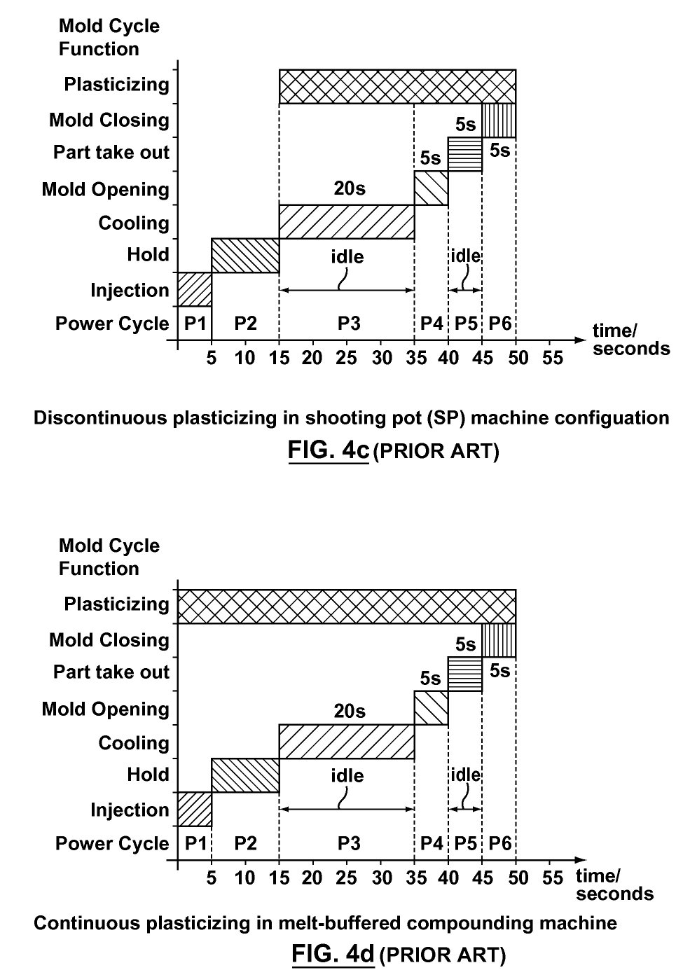

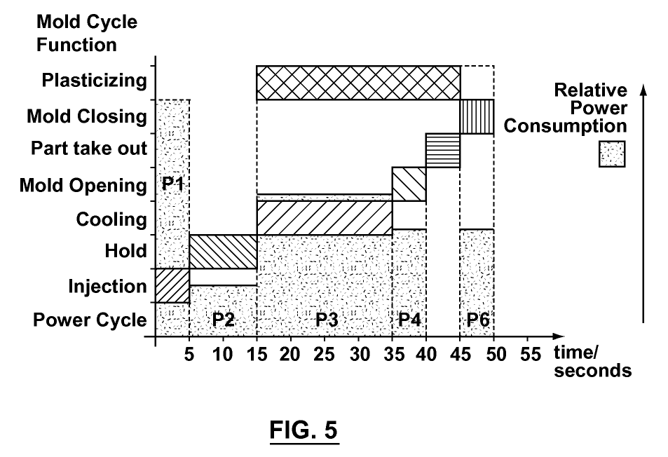

In terms of operation, this can best be understood by contrasting FIGS. 4a-d (which shows relative timing of hydraulically controlled machine functions for various machine configurations) with FIG. 5 (which is a timing diagram that shows relative timing of hydraulically controlled machine functions for the system of FIG. 3).

In a typical large tonnage molding cycle of about 50 seconds (see FIG. 4a to 4d), the cycle can be broken down to the following functions and timing:

| Function | Duration | Total elapsed cycle |
|---|---|---|
| (& Power Consumption) | (seconds) | (seconds) |
| Injection (P₁) | 5 | 5 |
| Hold (P₂) | 10 | 15 |
| Cooling (P₃) | 20 | 35 |
| Mold Opening (P₄) | 5 | 40 |
| Part take-out (P₅) | 5 | 45 |
| Mold closing (P₆) | 5 | 50 |

Injection, hold and mold movement functions consume approximately 50% of the total cycle. Consequently, during the remaining part of the cycle (i.e. cooling and part take-out), the pumps perform no function and thus conventionally run “idle”, whereby about 20%-25% of the available/nominal installed power (of the electric motor 30) is nevertheless consumed. The reason for running the pumps idle is to provide low flow and appropriate pressure to the various valves within the hydraulic system. Therefore, in terms of the power pack 28 and operation of its motor 30, energy from the motor 30 has hitherto resulted in continuous loading of the associated pumps that each independently control, for example, clamp force, hold, mold motion, injection, etc.

In terms of plasticizing, this can clearly be achieved in continuous and discontinuous processes in a machine configuration having a shooting pot or a melt buffer; this machine configuration is typical for in-line compounding applications. An alternative machine configuration is that realized with a reciprocating screw (or RS unit).

The following table highlights the periods over which plasticizing occurs in these various machine configurations.

| | Plasticizing (Yes/No) | | | | | |
|---|---|---|---|---|---|---|
| | | | | Mold | Part | Mold |
| | Injection | Hold | Cooling | Opening | take-out | closing |
| System Configuration | (P₁) | (P₂) | (P₃) | (P₄) | (P₅) | (P₆) |
| Reciprocating screw | No | No | Yes | No | No | No |
| (RS), sequential | | | | | | |
| plasticizing process | | | | | | |
| Reciprocating screw | No | No | Yes | Yes | Yes | Yes |
| (RS), simultaneous | | | | | | |
| plasticizing process | | | | | | |
| Compounding/TSE | No | No | Yes | Yes | Yes | Yes |
| machine, shooting pot | | | | | | |
| configuration - | | | | | | |
| discontinuous process | | | | | | |
| (dedicated electric | | | | | | |
| motor for TSE & idle losses) | | | | | | |
| Melt-buffered | Yes | Yes | Yes | Yes | Yes | Yes |
| compounding/TSE | | | | | | |
| machine, continuous | | | | | | |
| plasticizing process | | | | | | |
| (dedicated electric | | | | | | |
| motor for TSE & idle losses) | | | | | | |

Turning now to FIG. 5, a fifth timing diagram shows relative timing of hydraulically controlled machine functions for the twin screw extruder system of the present invention, as shown and described above in relation to FIGS. 2 and 3. As can now be seen, the hydraulic motor drive 104 is operated during periods when the pumps previously ran “idle, i.e. the hydraulic motor drive 104 effects plasticizing during the cooling, mold opening and part take-out phases. In all cases of plasticizing, idle time losses previously associated with the motor 30 in the power pack 28 are reduced or eliminated. It is possible to extend the plasticizing period into the mold closing time/phase of the overall process, although the energy saving gained by this extension is negligible because energy is being soaked from the pumps during mold closing. In other words, the pumps are under load during mold closing and thus there are no idle losses.

As will now be appreciated with particular regard to FIG. 5, plasticizing can now be achieved during, at least, the cooling and part take-out phases/periods, with the energy derived from the motor 30 in the power pack 28. FIG. 5 also shows the typical (relative) power requirements for the various phases of the injection process. For example, the power required during injection represents the highest drain of the resources of the motor, whereas zero (or minimum) power is required during part take-out. The second highest power consumption is caused by plasticizing during cooling, while power consumption during mold opening and closing is essentially equal but marginally lower than the power consumption during cooling. Finally, power consumption during hold is higher than that during part take-out, but lower than that required for mold opening/closing. Expressed mathematically, P₁>P₃>P₄(≈P₆)>P₂>P₅ (=0).

For simultaneous process (sometimes referred to as parallel processes), it may be necessary to increase the size of the motor in the power pack to accommodate combinations of certain processing functions, e.g. plasticizing and mold movement. However, in all case, the system benefits from increased efficiency since wasted energy through idle losses is eliminated. In fact, the larger the motor (associated with progressively larger tonnage machines), the greater the energy saving because the percentage power consumption associated with nominal idle losses in the prior art remains generally constant.

As will be appreciated, control of the various pumps and functions is typically achieved through a processor-controlled closed loop mechanism.

In one particular embodiment, the gear box of the system of FIG. 2 may be eliminated, whereby there's direct drive of individual screw shafts through dedicated hydraulic motor drives (104) assigned to each shaft.

It will, of course, be appreciated that the above description has been given by way of example only and that modifications in details may be made within the scope of the present invention. For example, while the preferred embodiment has been described in relation to an in-line compounding environment, the principals of the present invention are more widely applicable to any sized machine (especially injection molding machines) in which dedicated extruder drives are historically used side-by-side with hydraulic pump circuits that are themselves driven by motors. Indeed, the present invention finds general application in injection molding technologies, irrespective of whether, for example, the injected material is a plastic, plastic composite or metal (as in the case of thixomolding technology).

1. An injection molding machine comprising:
a twin screw extruder including at least one rotating screw;
a power pack including:
a motor;
a plurality of pumps each for effecting an injection molding function; and
a hydraulic circuit coupling the motor to the plurality of pumps such that the motor can selectively provide energy to each pump to manage its respective molding machine function;
a hydraulic motor drive coupled to the twin screw extruder to effect and control rotation of the twin screw extruder, the hydraulic motor drive connected into the hydraulic circuit such that the hydraulic motor drive selectively receives energy from the motor to cause controlled rotation of the twin screw extruder.

2. The injection molding machine according to claim 1, further including a variable displacement pump coupled between the motor and the hydraulic motor drive, the variable displacement pump arranged, in use, to provide hydraulic energy to the motor at least during one period when one of the plurality of pumps is idle and thus not operational to support its respective injection molding function.

3. The injection molding machine according to claim 2, further including a gearbox coupled between the hydraulic motor drive and the twin screw extruder.

4. The injection molding machine according to claim 3, wherein the injection molding machine is a compounding machine.

5. The injection molding machine according to claim 2, further including a soft start valve connected in the hydraulic circuit between the variable displacement pump and the hydraulic motor drive.

6. The injection molding machine according to claim 2, further including a tank return preloaded check valve connected in the hydraulic circuit between the hydraulic motor drive and a reservoir.

7. A method of operating an injection molding machine comprising: a twin screw extruder; a power pack having a hydraulic circuit, a plurality of pumps each controlling an active injection molding function and a motor coupled to the plurality of pumps through the hydraulic circuit selectively to actuate each injection molding function; and a hydraulic motor drive connected to the hydraulic circuit and the twin screw extruder, the method comprising:
drawing energy from the motor in the power pack to operate the hydraulic motor drive to cause rotation of the twin extruder, the energy provided during at least a period of time when at least one of the plurality of pumps is idle and thus not actively supporting its assigned injection molding function.

8. The method according to claim 7, wherein an injection molding cycle includes an injection time, a hold time, a cooling time and a machine operating time, the method further comprising:
operating the hydraulic motor drive to drive the twin screw extruder during at least the cooling time.

9. The method according to claim 8, further comprising:
in a continuous operation, extending the plasticizing function by adjusting one of:
the rotation speed of extruder; and
the throughput through the extruder.

10. A method of operating a twin screw extruder in a molding machine having a plurality of pump-controlled machine functions, the method comprising:
in periods where the pump-controlled machine functions are inoperative, using available energy from a motor dedicated to the pump-controlled machine functions to energize a hydraulic motor drive to cause controlled rotation of the twin screw extruder.
